(19) United States
(12) Patent Application Publication
(10) Pub. No.: US 2010/0191453 A1
(43) Pub. Date: Jul. 29, 2010

(54) SYSTEM AND METHOD FOR PROVIDING WIRELESS EMERGENCY ALERTS WITH ROUTING INFORMATION

(75) Inventor: Scott Cameron, Kansas City, MO (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/358,981

(22) Filed: Jan. 23, 2009

(51) Int. Cl. G01C 21/36; H04W 4/02

(52) U.S. Cl. 701/201; 455/456.3; 701/207

(57) ABSTRACT

A system and method for notifying users of situations may include identifying geographic coordinates of the situation in response to receiving situation information. A communications device located within a geographic distance from the geographic coordinates may be identified. A network address of the communications device may be determined. A route for a user of the communications device to avoid the situation may be determined and communicated in a message to the communications device. The message may include an indication of the situation and the determined route to notify the user of the situation and route to avoid the situation.

### BACKGROUND

Hazardous conditions and other situations (“situations”) happen in many ways. Situations may be in the form of tornadoes, severe thunderstorms, flooding, wildfires, hurricanes, blizzard conditions, toad closures, vehicular accidents, chemical spills, and many other situations. While television and radio are two forms of communication to notify the public about situations, many situations require that notification to the public occurs faster than is generally delivered by radio and television, such as a typical 10 minute traffic or weather update. Many commuters and residents do not listen to radio or watch television, while others do not listen to or watch channels that report news. Often, it is not necessary to notify an entire city or region of a particular situation, but only people who are in proximity to the situation.

With the widespread use of mobile telephones and other wireless devices, being able to notify people via wireless devices has been a way to notify users of the situations. However, the mere notification of a situation, in many cases, is not enough information for individuals to easily or properly respond.

### SUMMARY

To overcome the shortcomings of notifying individuals of situations via wireless devices, the principles of the present invention provide for communicating messages to wireless devices to notify a user of a situation and provide a route to the user to avoid the situation. Geographic coordinates of the wireless devices may be determined to determine whether the wireless devices are within a geographic distance of the situation and, if so, determine and communicate routes to the users. The routes may be determined in such a manner as to avoid causing significant congestion of vehicles being routed for detour or evacuated from an area.

One embodiment of a system and method for notifying users of situations may include identifying geographic coordinates of the situation in response to receiving situation information. A communications device located within a geographic distance from the geographic coordinates may be identified. A network address of the communications device may be determined. A route for a user of the communications device to avoid the situation may be determined and communicated in a message to the communications device. The message may include an indication of the situation and the determined route to notify the user of the situation and route to avoid the situation.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an illustrative map in which a tornado is moving through an area that includes a roadway;

FIG. 2 is an illustration of an illustrative roadway that has a vehicular accident that has occurred thereon;

FIG. 3 is an illustration of an illustrative communications network in which situation information is being fed to a telecommunications system, which, in response to receiving situation information, communicates the situation information to wireless communications devices;

FIGS. 4A and 4B are illustrative screenshots of text messages that have situation information and routing instructions for a user to follow to avoid the situation;

FIG. 5 is a block diagram of an illustrative server configured to receive and process situation information, and communicate the situation information to users via a communications network;

FIG. 6 is a block diagram of illustrative software modules configured to process situation information and generate routing instructions for communication to users of wireless communications devices; and

FIG. 7 is a flowchart of an illustrative process for processing and communicating situation information and routing information in accordance with the principles of the present invention.

### DETAILED DESCRIPTION OF THE DRAWINGS

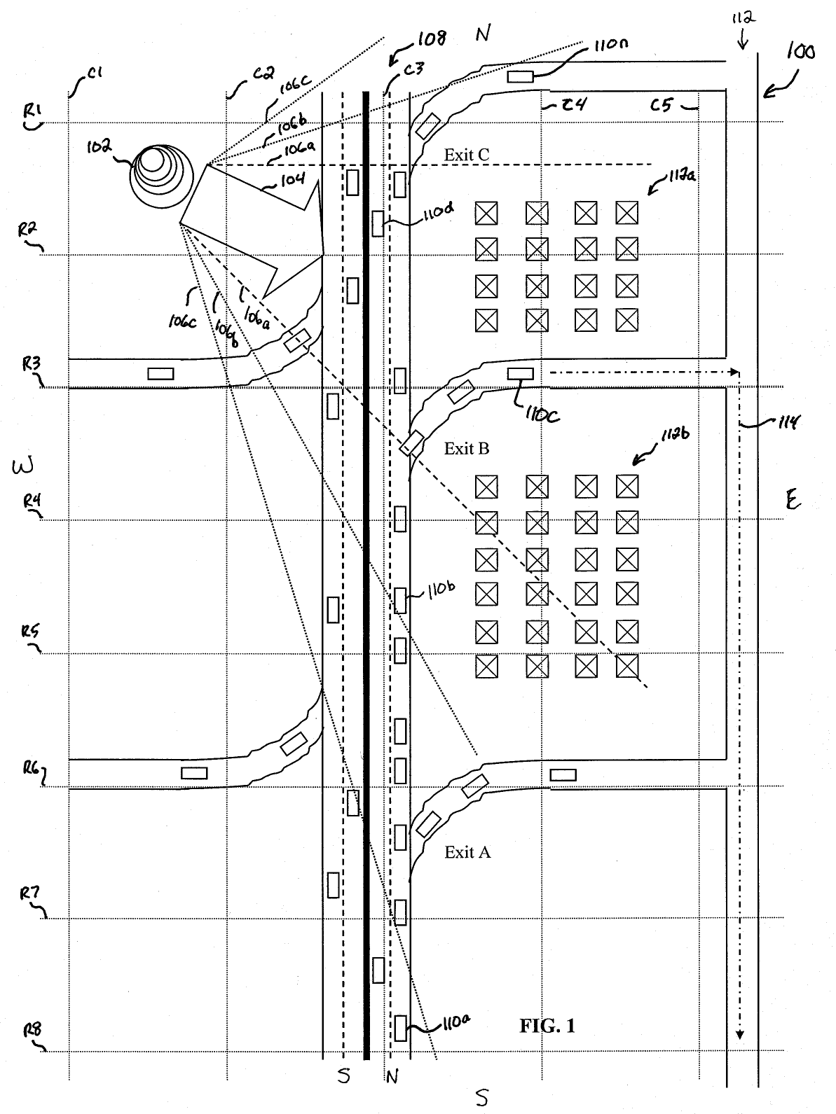

With regard to FIG. 1, an illustrative geographic area 100 is shown to include a tornado 102, which represents an emergency situation impacting the geographic area 100. The tornado 102 is moving along a path 104. As understood, the path 104 may be contained within various sectors 106a, 106b, and 106c, which define highest to lowest percentage chance that the tornado 102 will move within each of the sectors.

As shown in the geographic area 100, a highway 108 is in the path 104 of the tornado 102. Vehicles 110a-110n (collectively 110) are traveling along the highway 108. In addition, housing developments 112a and 112b (collectively 112) reside near the highway 108 and potentially in the path 104 of the tornado 102. As shown, the geographic locations of each of the vehicles 110 and housing developments 112 with respect to the tornado 102 and path 104 of the tornado 102 make notification of the tornado 102 to operators of the vehicles 110 and people within the residential housings 112 important for preventing serious injury or death. In accordance with the principles of the present invention, messages of the situation, in this case the tornado 102, may be communicated to wireless devices (not shown) of people in the vehicles 110 and housing developments 112. The messages may be in the form of text messages, e-mails, instant messages, audio messages, video messages, or any other electronic message as understood in the art.

As further provided by the principles of the present invention, geographic coordinates of the wireless devices (not shown) may be determined so that routing instructions may be generated for each of the users to follow to avoid the situation. In one embodiment, if a user is traveling in a vehicle, then current traveling direction of the vehicle may be determined so as to determine the route instructions. In addition, the path of the tornado 102 may be determined so that the routing instructions may be determined to avoid placing the people within the path 104 of the tornado 102. In determining the routing instructions, a destination point that avoids the situation may be selected and the route instructions may be calculated from the current geographic location of the user and the selected destination point. To avoid creating roadway congestion, different route instructions (i.e., driving directions) may be generated for different sets of users.

To illustrate how routing instructions may be generated in accordance with the principles of the present invention the geographic area 100 is subdivided by rows R1-R8 and columns C1-C5. The rows and columns result in a grid being formed over the geographic area 100. In addition, the sectors 106a, 106b, and 106c in which the path 104 of the tornado 102 may travel are shown to extend over the grid defined by the tows and columns. As each of the vehicles 110 are driving along the highway 108, the vehicles may be geographically located in a more high risk or low risk geographic area based on the situation (i.e., the tornado 102 and its path 104). Using the path 104, sectors 106a, 106b, 106c, may be determined so as to determine a geographic distance that may be impacted by the situation. Any wireless devices determined to be within the geographic distance may be candidates for notification of the situation.

The geographic distance may be dependent upon a particular situation that is currently occurring or to be occurring. For example, an auto accident may have a geographic distance of one mile for non-rush hour traffic times and two or more miles for rush-hour traffic times. A weather situation, such as a tornado, hurricane or otherwise, may have different geographic distances. A tornado may have a five or ten mile geographic distance and a hurricane may have a 25, 50, or higher number of mile geographic distance selected for notification to alert users of the impending tornado or hurricane and a route for avoidance or evacuation purposes.

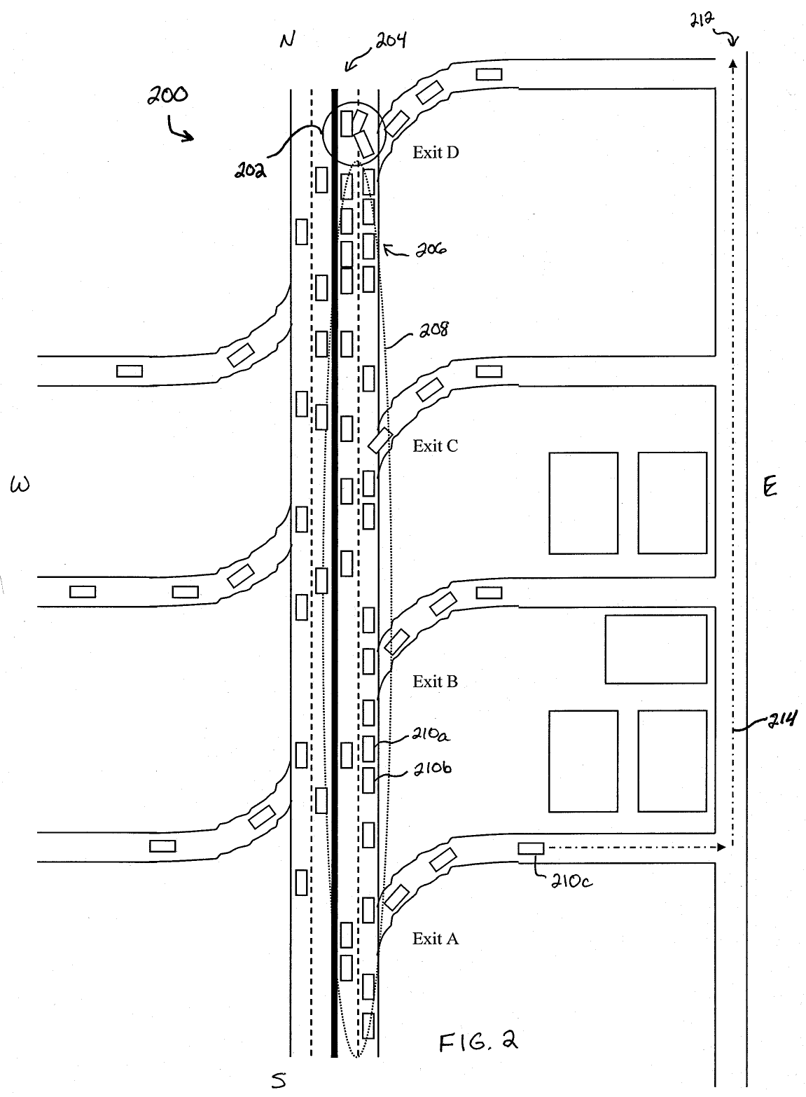

The geographic distance may also be dependent on direction of a user with respect to the situation. As shown, the tornado 102 is taking the path 104 that will affect people within the sector 106a more than those outside of that sector. In the case of a traffic accident, the geographic distance may be a distance of a mile for users traveling in a northbound direction and a quarter or half mile for those traveling in a southbound direction if the traffic accident occurred in the northbound lanes (see FIG. 2). As an example, as the vehicles 110 traveling in the northbound lane pass through each of the rows toward the path 104, the route instructions notify the users to exit from the highway 108. For example vehicle 110a may receive a message to exit at Exit A and head south onto roadway 112. As another example, vehicle 110b is shown to be between rows R4 and R5 and columns C3 and C4, which is also between sectors 106a and 106b. As the tornado 102 is impending, vehicle 110b is notified to exit on Exit B and turn south on roadway 112, as indicated by vehicle 110c and dash-dot line 114. As vehicle 110d is above the path 104 of the tornado 102, a message to the user of vehicle 110d may be to continue on the highway 108 to avoid the situation of the tornado 102 by exiting sectors 106a, 106b, and 106c as quickly as possible. If a message is sent to a user in the vehicle 110n as it is exiting Exit C, then the message will indicate to the user to head north on roadway 112 so as to avoid the path 104 of the tornado 102.

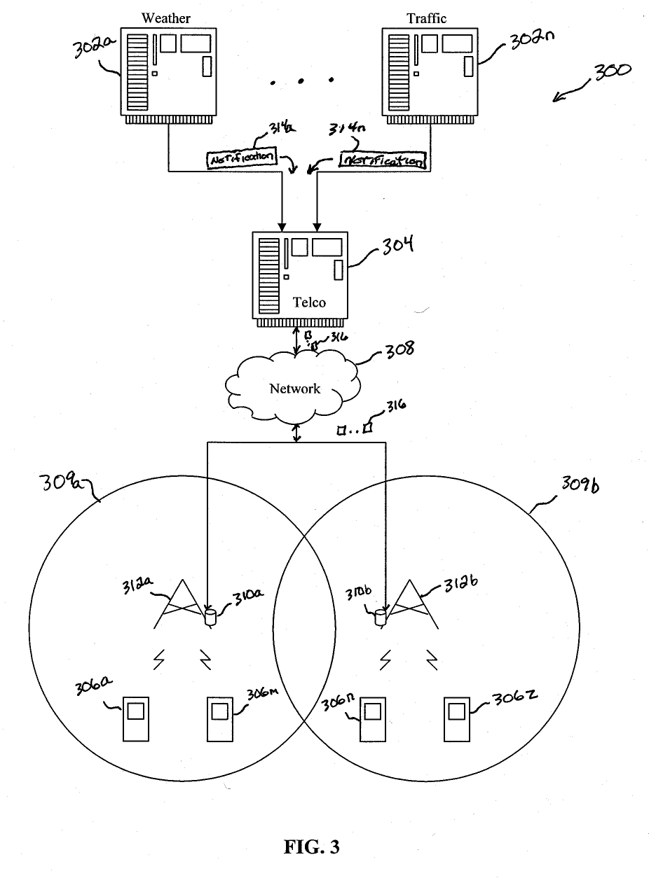

With regard to FIG. 2, an illustrative geographic area 200 is shown to include a vehicular accident 202 in the northbound side of the highway 204. In accordance with the principles of the present invention, a communications system (see FIG. 3) may receive a traffic alert indicating that an accident has occurred at a particular geographic location, which is substantially collocated at Exit D. The communications system, or other computing system, may identify the geographic coordinates of the situation (i.e., automobile accident 202 at Exit D) and determine a geographic distance, represented by an ovular dashed line 208, within which to notify users of communications devices (e.g., mobile telephones). As shown, a backup of vehicles 206 is shown at the automobile accident 202. The system determining the geographic coordinates of the situation or another system may further determine geographic coordinates of all communications devices (e.g., mobile telephones) within the geographic distance of the automobile accident 202. Once the communications devices are identified, the system may determine network addresses (e.g., telephone number, mobile ID number, or any other network address associated with a communications device) and determine routing information (i.e., driving directions) for each respective user. To prevent or otherwise avoid congestion, the system may generate different routes for users who are located near one another. For example, with reference to FIG. 1, users in the residential housing 112a may be given routing information to route the residents in different directions or along different roadways so as to avoid causing congestion trying to exit the housing development 112a.

Continuing with FIG. 2, two vehicles 210a and 210b may be traveling north on the highway 204. In generating route information for the users of the vehicles 210a and 210b, the route information may be different for each of the vehicles to avoid creating congestion along the detours for each of the vehicles 210a and 210b. For example, vehicle 210a may be routed via Exit B and vehicle 210b may be routed via Exit C. Vehicle 210c may have been routed via Exit A and along roadway 212, as indicated by dash-dot line 214, to bypass the traffic accident 202. It should be understood that the example shown in FIG. 2 is illustrative and that alternative techniques for routing vehicles in a manner to avoid creating congestion may be utilized. For example, in a situation where a local incident, such as a chemical spill from a train crash, occurs, residents within a geographic distance (e.g., 1 mile around or downwind) of the train crash may be routed from their residences radially outward so that a single main roadway is not overly congested by route instructions given by the system.

With regard to FIG. 3, an illustrative network environment 300 configured to provide for situation notification to users within a geographic distance of a situation is provided. The network environment 300 may include one or more servers 302a-302n (collectively 302), such as a weather server 302a and a traffic server 302n, which operate to collect and distribute information about weather and traffic, respectively. In one embodiment, the weather server 302a is operated by a national weather service, and the traffic server 302n is operated by a regional traffic service provider, such as a television channel. It should be understood that other servers configured to collect and distribute information associated with other types of situations may be utilized to collect and distribute situation information in accordance with the principles of the present invention.

A telecommunications server 304 may be operated by a telecommunications service provider to enable wireless communications devices 306a-306m and 306n-306z (collectively 306) to operate over a communications network 308. Wireless communications devices 306a-306m are operating within a cell 309a and wireless communications devices 306n-306z are operating within a cell 309b. Within each of the cells 309a and 309b, base stations 310a and 310b, respectively, may operate to enable the wireless communications devices 306 to communicate with cell towers 312a and 312b for communication with the telecommunications server 304. Each of the base stations 310a and 310b may be configured to manage one or more databases, such as home location register (HLR) and visitor location register (VLR) databases, so as to keep track of communications devices are operating with each of the respective cells 309a and 309b.

In operation, the servers 302 may collect information about respective topics (e.g., weather and traffic) and communicate situation notifications 314a-314n (collectively 314) to the telecommunications server 304. The situation notifications 314 may include a situation type and geographic coordinates. In addition, path or expected path of the situation may be included in the situation notifications 314. The telecommunications server 304, which may be formed of one or more computing systems, may process the situation notifications 314 to determine the situation type, geographic coordinates of the situations, and any possible users who may be impacted by the situations based on geographic locations of communications devices associated with the users. In determining the situation type, geographic coordinates of the situation, and path of the situation, the telecommunications server 304 may parse the situation notifications 314 and store the information to generate and communicate messages to subscribers that are determined to be within a geographic distance determined to be affected by the situation. Determination of the geographic locations of the communications devices 306 may be made using global positioning system (GPS) technology, network assisted GPS technology, triangulation, or otherwise.

Because public alert messages or broadcasts may alarm the public, governmental authorities often reserve the right or ability to make a final decision as to whether to issue public alert messages, such as situation notifications 314. Situation notifications 314 may be initiated by national, regional, or local authorities. In one embodiment, the telecommunications server 304 may be configured with an algorithm established with pre-established parameters (e.g., tornado detected parameter) that automatically causes the situation notifications 314 to be communicated. The algorithm may also be configured to require a final manual interaction prior to communicating the situation notifications 314.

Notification of the situations identified in the situation notifications 314 may be communicated to the identified wireless communications devices 306 in data packets 316, as understood in the art. In one embodiment, the data packets 316 may contain messages, such as text messages, for distribution to the wireless communications devices 306 for display thereon, as understood in the art. It should be understood that other forms of messages, including e-mail messages, instant messages, video messages, photo messages, and any other message that may be communicated to communications devices 306 may be utilized. It should be understood that although communications devices 306 are shown to be wireless communications devices that communicate via cell towers 312a and 312b, that the wireless communications devices 306 may additionally and/or alternatively be communications devices that receive communications via network access devices other than cell towers, such as WiFi network access devices. Still yet, the notifications may be communicated to fixed communications devices, such as wired telephones or computers that are configured to receive and display messages communicated by the telecommunications server 304, as further described herein.

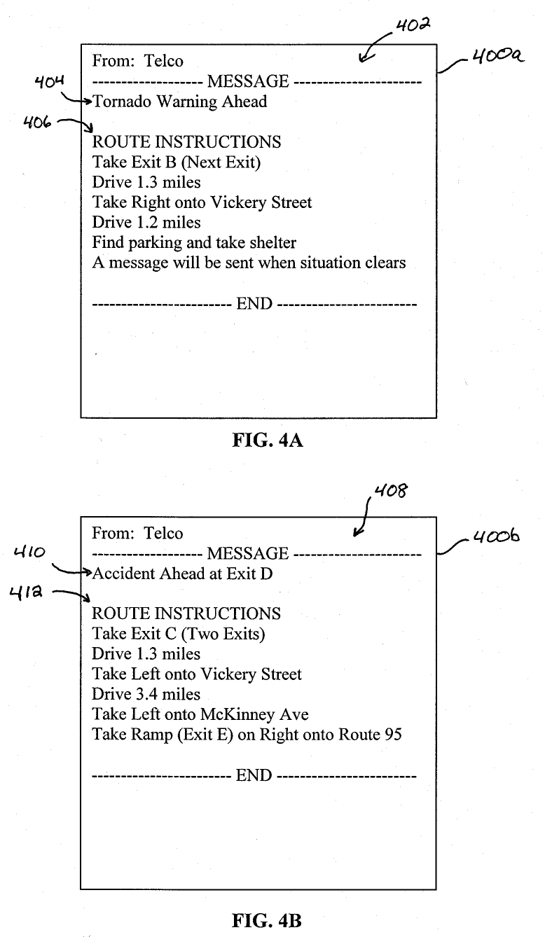

With regard to FIGS. 4A and 4B, screenshots of illustrative graphical user interfaces 400a and 400b are provided. The graphical user interfaces 400a and 400b may be graphical user interfaces displayed on a wireless communications device, such as a mobile telephone, Blackberry®, or any other wireless communications device capable of receiving text messages. In the graphical user interface 400a, an illustrative text message 402 is displayed. The text message 402 may be received from the telecommunications service provider to which the user subscribes. In the text message, a situation indication 404 may be used to notify the user of the particular type of situation that he or she may encounter and route instructions 406 for the user to follow to avoid the situation. The route instructions 406 may be determined for the user so as to avoid congestion that may be created on roadways as a result of the situation.

In the graphical user interface 400b, an illustrative text message 408 is shown to be received from the telecommunications service provider to which the user subscribes. However, it should be understood that the text message 408 may be received from a telecommunications service provider or other service provider, including governmental service providers, to notify the user of a particular situation. The text message 408 may include a situation indicator 410 that indicates that an accident is located at Exit D. Route instructions 412 may be provided to provide specific directions to the user to avoid the situation so as to place the user back onto the highway ahead of the situation.

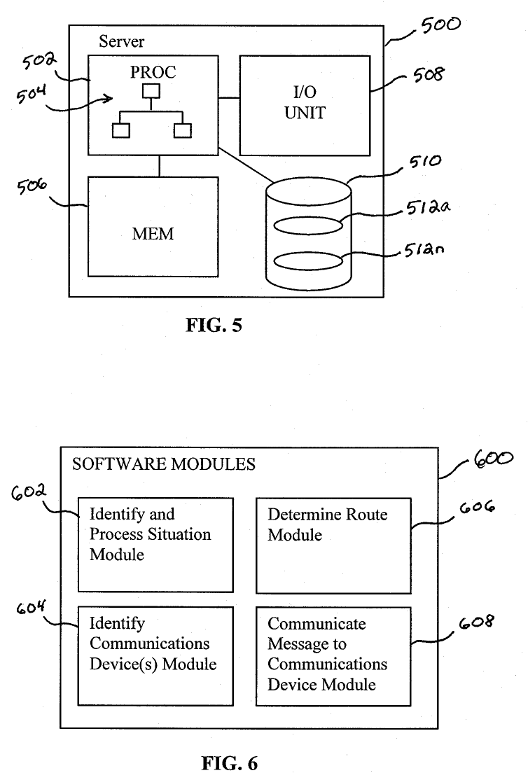

With regard to FIG. 5, a block diagram of an illustrative server 500 is shown. The server 500 may include a processing unit 502 formed of one or more computer processors that executes software 504. The processing unit 502 may be in communication with a memory 506, input/output (I/O) unit 508, and storage unit 510. The storage unit 510 may be configured to store one or more databases 512a-512n (collectively 512). The databases 512 may store information associated with subscribers of a communications service provider, where the information may include name, telephone number, wireless device ID number, home address, telephone number, and any other information associated with the subscriber or communications device(s) utilized by the subscriber.

In operation, the server, which may be the telecommunications server 304 of FIG. 3, may receive situation notifications from other servers via a communications network, such as the Internet. The situation notifications may be processed by the software 504 to determine the type of situation, current geographic coordinates of the situation, and any other information associated with the situation that may be helpful to notifying a subscriber at or near the situation, as further described herein.

With regard to FIG. 6, software modules 600, which may be part of the software 504 of FIG. 5, may be configured to perform situation processing and notification functionality in accordance with the principles of the present invention. An identify and process situation module 602 may be configured to process situation notifications that are received from other servers, such as traffic and weather servers. In identifying a situation, a list of potential situations may be stored and accessed to determine information, including geographic distances that situation messages should be communicated to wireless devices within the geographic distances, cell sites that are within the geographic distance associated with the situation, and any other information that may be useful for notifying users of the situation.

An identify communications device(s) module 604 may be configured to, based on the situation and geographic distance determined for messages to be communicated to communications devices, may be configured to determine geographic coordinates or positions of communications devices associated with subscribers or customers of the communications service provider. In determining the geographic coordinates of the communications devices, one or more techniques may be utilized, including requesting GPS positions of the communications devices, performing a network assisted GPS process to determine geographic coordinates of the communications devices, looking up address information associated with wired communications devices, or utilizing any other technique in determining geographic positions of the communications devices. In one embodiment, the geographic coordinates of the communications devices may be converted to determine specific roadways or structures at which the communications devices are located. For example, if a fire situation is reported at a particular building, such as a high-rise tower, then the identify communications device(s) module 604 may determine any communications devices that are positioned at or near the high-rise building. As another example, if a tornado notification is received, then the identify communications device(s) module 604 may identify any communications devices that are in the path of the tornado based on geographic coordinates as opposed to roadway or other structural coordinates.

A determine route module 606 may be configured to receive the geographic coordinates of the identified communications devices and determine a route that will take the user to avoid the situation. The determine route module 606 may include maps with global positioning system coordinates associated therewith so as to identify the geographic coordinates of the situation and geographic coordinates of the user so as to route the user away from or around the situation. In one embodiment, the determine route module 606 may communicate with another server that is configured to perform mapping and routing functions over a communications network, as understood in the art. The determine route module 606 may determine that the communications device is located on a roadway and traveling in a particular direction, such as north, by receiving multiple communications from the communications device, thereby providing an indication as to the direction of travel.

From the geographic coordinates of the communications device and direction of travel, a destination point that avoids the situation may be selected. In selecting the destination point, the destination point may be selected from among a number of different destination points that are to be communicated to communications devices within the geographic distance (i.e., range and direction) of the situation so as to avoid sending too many users within the geographic distance of the situation to the same location and along the same pathways. The determine route module 606 may further select different routes to a particular destination that is different from routes communicated to other users that are being routed to the same destination point. For example, if an accident has occurred on a highway, a determination as to the number of users that are within the geographic distance from the accident situation may be determined and half may be routed to take a first exit and the other half may be routed to take the second exit, thereby alleviating congestion at a single exit. Furthermore, the determine route module 606 may be configured to form sub-geographic regions within a geographic region that is defined by the geographic distance associated with the situation. The sub-geographic regions may be utilized to identify communications devices within each of the sub-geographic regions so as to provide different route instructions to users in each of the sub-geographic regions so as to, again, avoid congestion along roadways for the users.

A communicate message to communications device module 608 may be configured to communicate route information to communications devices. The route information may be communicated in data messages, such as text messages, e-mails, instant messages, or any other messages, as understood in the art. In communicating the messages, the communicate message to communications device module 608 may access a database that includes information associated with each of the communications devices, where the information may include network address information (e.g., telephone number, e-mail address, network ID address, or any other address to which a message may be communicated) and desired message type for the messages to be communicated. The desired message types may include text messaging, voice messaging, instant messaging, e-mail messaging, and so on. In one embodiment, a user may establish the type of message to be communicated by speaking with a customer service representative or via a website.

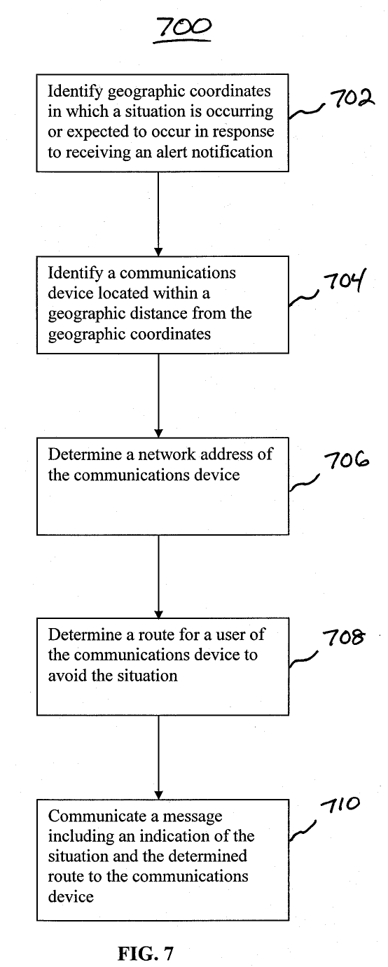

With regard to FIG. 7, a flow chart of an illustrative process 700 for providing emergency alerts with routing information is provided. The process 700 starts at step 702. At step 704, geographic coordinates to which a situation is occurring or expected to occur in response to receiving an alert notification may be identified. The alert notification may be received at a communications system from a governmental agency, weather service, or any other service provider. At step 704, a communications device located within a geographic distance from the geographic coordinates may be identified. The geographic coordinates may indicate both distance and direction from a situation, such as a chemical spill or vehicular accident on a highway. At step 706, a network address of the communications device may be determined. The network address may be a telephone number, email address, network ID, or otherwise that enables for an electronic message to be communicated to the communications device.

At step 708, a route for a user of the communications device to avoid the situation may be determined. The determination may be made by the communications system or by another system in communication with the communications system. To avoid the situation, an endpoint may be selected that causes a route to be generated that avoids the situation. For example, the endpoint may be upwind of a chemical leak, in the opposite direction of a tornado, or around a vehicular accident. At step 710, a message including an indication of the situation (e.g., “TORNADO ALERT”) and the determined route may be communicated to the communications device. The communication may be in the form of a text message or otherwise and include the determined route in the form of text (e.g., driving instructions) and/or graphical representation (e.g., map).

Although particular embodiments of the present invention have been explained in detail, it should be understood that various changes, substitutions, and alterations can be made to such embodiments without departing from the spirit and scope of the present invention as defined solely by the following claims.

What is claimed:

1. A method for notifying users of situations, said method comprising:
in response to receiving situation information, identifying geographic coordinates of the situation;
identifying a communications device located within a geographic distance from the geographic coordinates;
determining a network address of the communications device;
determining a route for a user of the communications device to avoid the situation; and
communicating a message including an indication of the situation and the determined route to the communications device to notify the user of the situation and route to avoid the situation.

2. The method according to claim 1, wherein determining the network address includes determining a telephone number of the communications device.

3. The method according to claim 1, wherein determining the route includes:
determining geographic coordinates of the communications device;
selecting a destination point to which the user is to travel to avoid the situation; and
determining driving directions for the route that avoids the situation.

4. The method according to claim 3, further comprising:
determining a path that the situation is traveling; and
wherein selecting the destination point includes selecting a destination point that is not in the path of the situation.

5. The method according to claim 3, further comprising:
determining routes for a plurality of other communications devices;
wherein determining driving directions includes determining directions that avoid congestions for the user based on routes for the other communications devices; and
communicating messages to the other communications devices including the routes.

6. The method according to claim 5, wherein determining routes for a plurality of other communications devices includes:
selecting a geographic region in which users of the communications devices are to be notified of the situation;
selecting a plurality of sub-geographic regions within the geographic region;
selecting respective destination points for each of the users within each of the sub-geographic regions to travel;
determining which geographic region each of the communications devices are located; and
generating routes for each of the users in the sub-geographic regions to take to reach a respective destination point.

7. The method according to claim 6, wherein generating routes for each of the users includes generating at least two different routes for users within a sub-geographic region to reach the same destination point.

8. The method according to claim 7, wherein generating at least two different routes includes selecting at least two different exits for the different users to exit from a highway.

9. The method according to claim 1, further comprising:
monitoring for a new communications device to enter within the geographic distance from the geographic coordinates;
determining a network address of the new communications device;
determining at least one route for a second user of the new communications device to avoid the situation; and
communicating a second message including an indication of the situation and the determined route to the communications device to notify the second user of the situation and route to avoid the situation.

10. The method according to claim 1, wherein communicating a message includes communicating a text message.

11. A system for notifying users of situations, said system comprising:
a memory;
an input/output (I/O) unit;
a processing unit in communication with said memory and I/O unit, and configured to:
in response to receiving situation information via said I/O unit, identify geographic coordinates of the situation;
identify a communications device located within a geographic distance from the geographic coordinates;
determine a network address of the communications device;
determine a route for a user of the communications device to avoid the situation; and
communicate a message including an indication of the situation and the determined route to the communications device via said I/O unit to notify the user of the situation and route to avoid the situation.

12. The system according to claim 11, wherein the network address is a telephone number of the communications device.

13. The system according to claim 11, wherein said processing unit, in determining the route, is further configured to:
determine geographic coordinates of the communications device;
select a destination point to which the user is to travel to avoid the situation; and
determine driving directions for the route that avoids the situation.

14. The system according to claim 13, wherein said processing unit is further configured to:
determine a path that the situation is traveling; and
wherein the selected destination point is not in the path of the situation.

15. The system according to claim 13, wherein said processing unit is further configured to:
determine routes for a plurality of other communications devices;
wherein the driving directions avoid congestions for the user based on routes for the other communications devices; and
communicate messages to the other communications devices including the routes.

16. The system according to claim 15, wherein said processing unit, in determining routes for a plurality of other communications devices, is further configured to:
select a geographic region in which users of the communications devices are to be notified of the situation;
select a plurality of sub-geographic regions within the geographic region;
select respective destination points for each of the users within each of the sub-geographic regions to travel;
determine which geographic region each of the communications devices are located; and
generate routes for each of the users in the sub-geographic regions to take to reach a respective destination point.

17. The system according to claim 16, said processing unit, in generating routes for each of the users, is configured to generate at least two different routes for users within a sub-geographic region to reach the same destination point.

18. The system according to claim 17, wherein said processing unit, in generating at least two different routes, is further configured to select at least two different exits for the different users to exit from a highway.

19. The system according to claim 11, wherein said processing unit is further configured to:
monitor for a new communications device to enter within the geographic distance from the geographic coordinates;
determine a network address of the new communications device;
determine at least one route for a second user of the new communications device to avoid the situation; and
communicate a second message including an indication of the situation and the determined route to the communications device to notify the second user of the situation and route to avoid the situation.

20. The system according to claim 11, wherein the message is a text message.
